(19) United States
(12) Patent Application Publication
(10) Pub. No.: US 2018/0350255 A1
(43) Pub. Date: Dec. 6, 2018

(54) AUTOMATED LEARNER-FOCUSED CONTENT DIVISIONS

(71) Applicant: Pearson Education, Inc., New York, NY (US)

(72) Inventors: Karen Taxier, Brooklyn, NY (US); Anne Fahlgren, Highlands Ranch, CO (US)

(21) Appl. No.: 15/610,373

(22) Filed: May 31, 2017

(51) Int. Cl. G09B 7/07; G06F 17/30; G06F 17/27; G09B 7/06; G09B 5/02

(52) U.S. Cl. CPC G09B 7/07; G06F 17/30339; G09B 5/02; G06F 17/30867; G09B 7/06; G06F 17/2705

(57) ABSTRACT

A customized table of contents for a course may be generated based off the needs of the teacher and/or the interests of the students. Core content for the course may be organized in a plurality of sections, e.g., chapters, topics, projects and/or reading assignments, with each section being broken down into one or more alternative blocks. The plurality of sections and alternative blocks may be stored in a database. Using answers from the teacher and/or determined interest of the students, the customized table of contents may be generated for the course. Current events may also be used in selecting and/or modifying alternative blocks for the course. Success rates from previously tried customized table of contents may be analyzed and feedback provided to the teacher in future courses to assist the teacher in creating better customized table of contents in the future.

### FIELD OF THE INVENTION

The present invention relates to methods for dynamically generating a customized table of contents and courseware for a course and automated learner-focused content divisions in the course.

### SUMMARY OF THE INVENTION

The invention is generally related to creating a customized table of contents for a course. Core content for the course may be organized as desired and stored in a database. The customized table of contents for the course may be generated from the core content based on answers and/or features of the teacher and/or the students. The customized table of contents may also be modified based on detected current events.

In an embodiment of the invention, a core content for a course may be stored in a database operating on one or more servers. The core content preferably comprises content, i.e., courseware, for a plurality of different possible customized table of contents for the course. The core content includes alternative material that may or may not be included as part of any particular customized table of contents.

The core content may be broken down into any number of desired sections. Sections may have any desired granularity and may have different granularities between themselves. As non-limiting examples, a section may represent (have a granularity of) one or more chapters, one or more topic(s), one or more class projects, one or more homework assignments, one or more illustrations, one or more pages, one or more paragraphs, and/or one or more reading assignments. The more sections the core content is broken down into, the greater the granularity of the customizations that may be made in creating a customized table of contents.

Each section may be broken into one or more alternative blocks. Each section may have any desired number of alternative blocks and different sections may have different numbers of alternative blocks. The more alternative blocks a section has, the more options are available in creating a customized table of contents.

A teacher interrogatory engine may display one or more questions and receive one or more answers to and from a client device operated by a teacher. The questions may be stored with the core content in the database. The questions may be of any desired types, but are preferably of the yes/no or multiple choice question types. The questions may be arranged in a hierarchy so that previous questions may be used to select or refine subsequent questions. Alternative, the same series of questions may always be asked.

An input of a table of contents generator may receive the one or more answers from the teacher interrogatory engine. The answers may be used to select an alternative block from one or more sections and/or the answers may be used to modify one or more alternative blocks.

A current events detector may parse a plurality of current event records from one or more current event sources (such as news feeds) to determine a current event relevant to one or more of the alternative blocks. The current events detector may modify one or more alternative blocks based on the current event, such as by replacing a reading assignment with a reading assignment related to the current event.

An output of the table of contents generator may transmit the customized table of contents to the client device operated by the teacher. The customized table of contents preferably comprises one and only one alternative block from each section in the plurality of sections. The customized table of contents may comprise modified alternative blocks in one or more sections based on one or more answers from the teacher and/or modified based on the current event determined by the current events detector.

A success rate analyzer may store in the database a success rate, possibly represented by a final grade of each student, and the customized table of contents. As additional course are offered and completed, a plurality of success rates and corresponding customized table of contents may be stored in the database. The success rate analyzer may analyze a plurality of success rates and associated customized table of contents after the completion of a plurality of courses using the core content. The success rate analyzer may notify the teacher via the client device as to which customized table of contents yielded higher success rates over other customized table of contents for the course.

In some embodiments, the success rate analyzer may also deliver information to the teacher regarding which alternative block(s) in which section(s) produced higher success rates over other alternative block(s) in the same section(s). As a non-limiting example, if the success rate analyzer reviewed a plurality of different customized table of contents and determined that those table of contents that included a particular block in a particular section statistically outperformed other customized table of contents that did not include that particular block in that particular section, the success rate analyzer may provide this information to the teacher. In addition, the success rate analyzer may look for patterns of alternative blocks in different sections that, when included in a customized table of contents, statistically outperform customized table of contents that do not include the pattern of alternative blocks. This information may also be presented to the teacher. In this manner, the success rate analyzer may inform the teacher as to which alternative block(s) or combination of alternative blocks are most contributing to the success rates of the students.

In another embodiment of the invention, one or more of the alternative blocks in one or more of the sections may be tagged with one or more topics. In a preferred embodiments, all of the alternative blocks in the same section are tagged with different topics.

A student interest engine may determine one or more interests for one or more students enrolled in the course. The student interest engine may determine one or more interests for the one or more students enrolled in the course using any desired method. As a non-limiting example, the student interest engine may read or parse the student records for the one or more students enrolled the class to determine major(s), minors and/or courses taken or currently registered for by each student. The student interest engine may assign a major or a minor as an interest of student. Thus, a student with a math minor may be assumed to have an interest in mathematics. The student interest engine may assign as an interest any courses taken or currently registered for by each student, particularly if the courses are electives.

The student interest engine may also display one or more questions to one or more students enrolled in the course and receive one or more answers back from the students. The questions may be stored with the core content in the database. The questions may be of any desired types, but are preferably of the yes/no or multiple choice question types. The questions may be arranged in a hierarchy so that previous questions may be used to select or refine subsequent questions. Alternative, the same series of questions may always be asked. The answers from one or more students may be used to assign one or more interests to each student or the answers from all of the students may be used to assign one or more interests for the entire class enrolled in the course.

An input of a table of contents generator may receive one or more interests of either a student or common interests of a plurality of students. The interests of the student or the most common interests of the students enrolled in the course may be used to select alternative blocks that are tagged with the same interests. In other words, if the student or students have an interest in history, alternative blocks tagged with history may be selected over alternative blocks that are tagged with different topics. In addition, or alternatively, the one or more interests of the student or most common interests of the students may be used to modify one or more alternative blocks. Thus, if the student or students have an interest in creative writing, a creative writing assignment may replace another assignment within an alternative block.

As described in the previous embodiment, a current events detector may receive and parse a plurality of current event records to determine a current event relevant to one or more alternative blocks in one or more sections. The current events detector may modify one or more alternative blocks based on the current event determined by the current events detector.

An output of the table of contents generator may transmit a customized table of contents to the client device operated by the teacher. A customized table of contents may be generated for each student enrolled in the course or a customized table of contents may be generated based on the most common interests of all of the students enrolled in the course.

The above features and advantages of the present invention will be better understood from the following detailed description taken in conjunction with the accompanying drawings.

### BRIEF DESCRIPTION OF THE DRAWINGS

FIG. 1 is a block diagram of a system for generating customized table of contents comprising a database of core content, a database of student records, a teacher interrogatory engine, a student interest engine, a table of contents generator, a success rate analyzer and/or a current events detector operating on one or more hardware servers. The system may receive and/or transmit information to a teacher or student via client devices and access one or more databases of current news events and/or one or more databases storing current academic publications.

FIG. 2 is an illustration of a database of core content for a course. The core content may be arranged in a plurality of sections (rows) with each section comprising one or more alternative blocks. The alternative blocks may be tagged with a topic which may be matched to one or more areas of interests of students.

FIG. 3 is a blown-up illustration of the first section and the second section of the database illustrated in FIG. 2 and provides specific examples of how each alternate block in a section may be related to one or more topics.

FIG. 4 is a simplified illustration of a database comprising a plurality of student records.

FIGS. 5-6 are a flowchart of a method for dynamically generating a table of contents and courseware for a course.

FIGS. 7-8 are a flowchart of a method for an automated learner-focused content divisions.

FIG. 9 is a flowchart of a method for creating a feedback loop to help teachers to evaluate different previously used customized table of contents.

FIGS. 10-13 illustrate questions that may be displayed on a client device of a teacher that, when answered, allow the teacher to customize a table of contents for the course.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

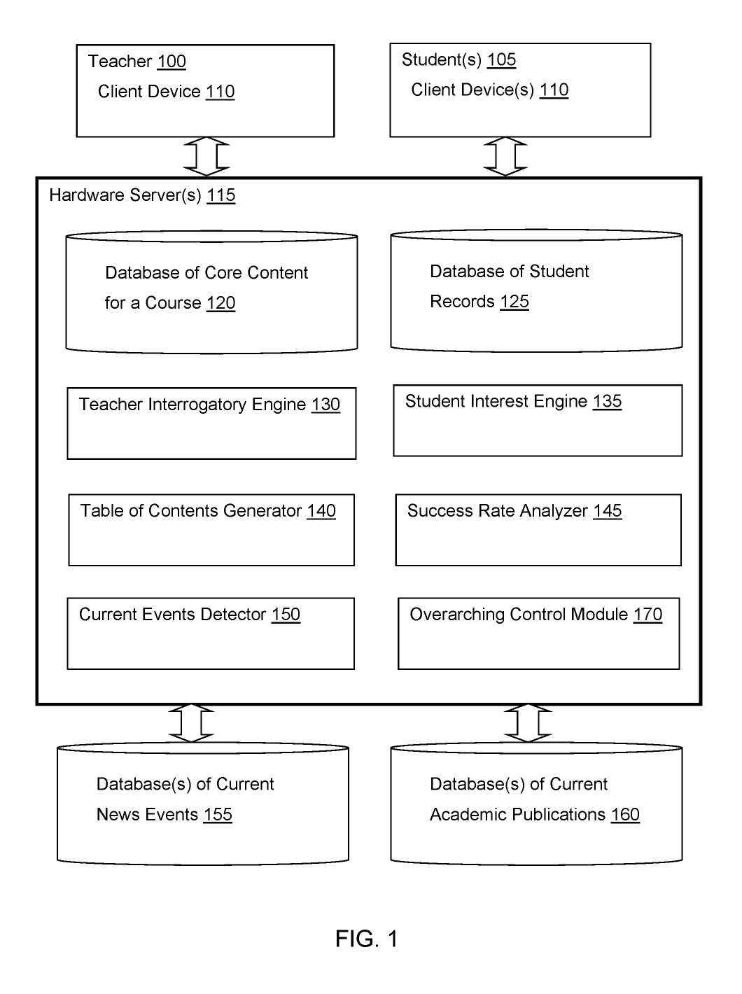

Referring to FIG. 1, a system is illustrated that allows a teacher 100 to create a customized table of contents for a course being taught by the teacher 100 and being taken by one or more students 105. The illustrated system may also allow one or more students 105 to create a customized table of contents for a course being taught by the teacher 100 and being taken by the one or more students 105. A table of contents may be customized for each student 105 or a table of contents may be customized based on all of the students 105 enrolled for the course.

Various embodiments of the invention include the teacher 100 and/or one or more students 105 communicating with one or more hardware servers 115 via client devices 110, operated by the teacher 100 or the students 105, which may be connected to a computer network, such as the Internet.

The client devices 110 may comprise a browser that generates an interface that may be used to receive and transmit information to and from the one or more hardware servers 115. Each client device 110 may have a touch screen to enable the teacher 100 and/or the students 105 to easily interact with the client device 110. The client devices 110 may be, as non-limiting examples, a desk top computer, a laptop computer, a tablet and/or a smart phone. As specific non-limiting examples, the client device 110 may be an Apple iPad™, a Samsung Galaxy Tablet™ and/or an AT&T Trek HD™ Tablet.

The client devices 110 may communicate over a computer network, such as the Internet, with the one or more hardware servers 115. The one or more hardware servers 115 may be any desired type of server that can receive and transmit data over the computer network and process the data. As non-limiting examples, the hardware servers 115 may be one or more Dell PowerEdge™ servers, Intel Server System™ servers and/or IBM eServer xSeries™ servers.

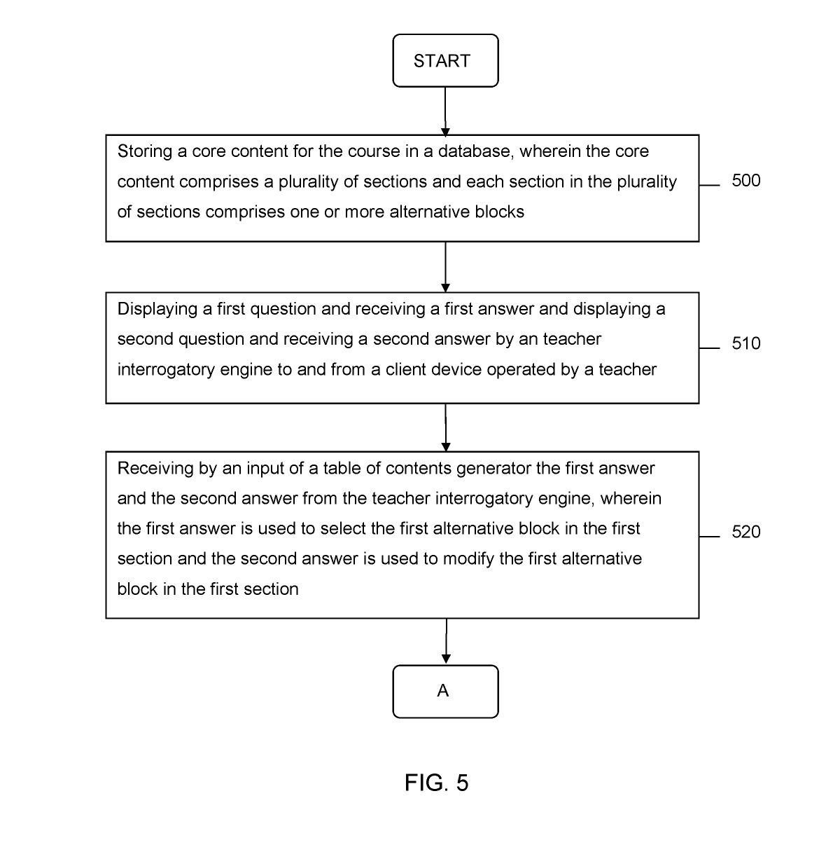

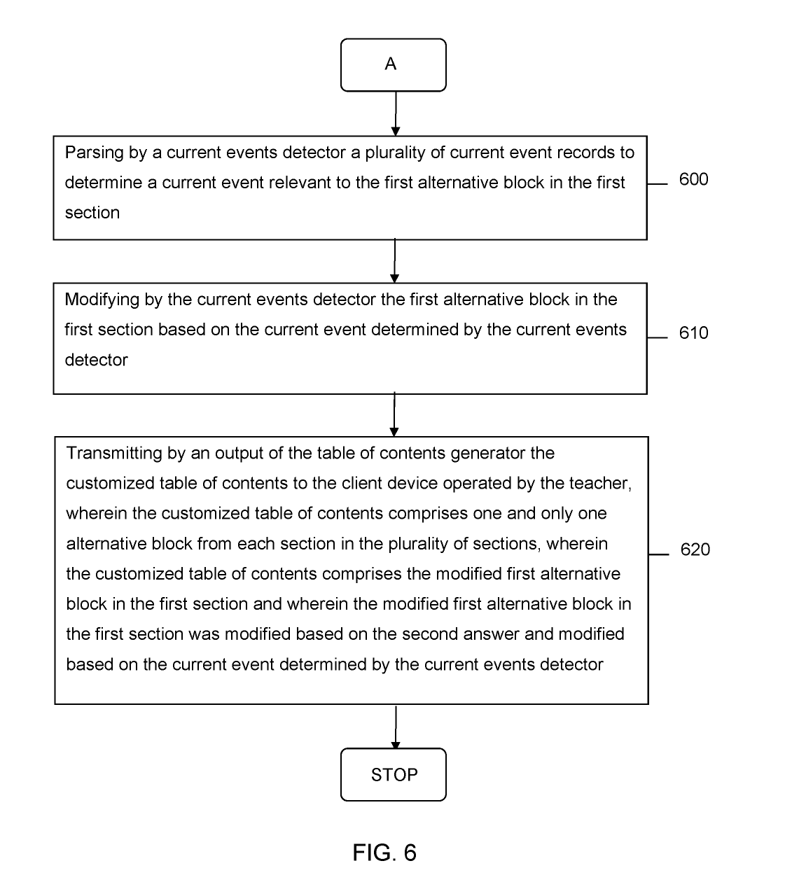

Referring to FIGS. 5-6, a method of practicing the invention may start by storing a core content for the course in a database 120 operating on one or more hardware servers 115. The illustrated system may comprise a database of core content for a course 120, a database of student records 125, a database of current news events 155, and a database of current academic publications 160. These databases 120, 125, 155 and 160 may be any type of database that can be updated and that can store data for extending period of times (such as years). As non-limiting examples, the databases 120, 125, 155 and 160 may be stored on one or more hard disk drives, solid-state drives or tape drives and may be a central or distributed database.

The core content may comprises a plurality of sections, which may be stored as rows in the database 120. Each section in the plurality of sections preferably comprises material that is generally taught during the same time period, but each section may be of any size and have any desired granularity.

As non-limiting examples, each section may represent one or more chapters of course material, one or more specific topics being taught in the course, one or more project, one or more reading assignment, one or more homework problems, vocabulary word(s), graph(s) and/or illustration(s). Typically, the greater the granularity of the material being taught in each section allows for a greater granularity in the customization of the table of contents for the course.

Each section in the plurality of sections in the core content may comprise one or more alternative blocks. The more alternative blocks, the more options that are available in creating a customized table of contents. While each section in the plurality of sections of the core content may have the same number of alternative blocks, preferred embodiments allow different sections to have, as desired, different numbers of alternative blocks.

This arrangement of core material, i.e., a plurality of sections, with each section comprising one or more alternative blocks, allows a customized table of contents to be created preferably by selecting one and only one alternative block from each and every section. In this embodiment, the number of possible table of contents is equal to the number of possible permutations of selecting one alternative block from each section. (Step 500)

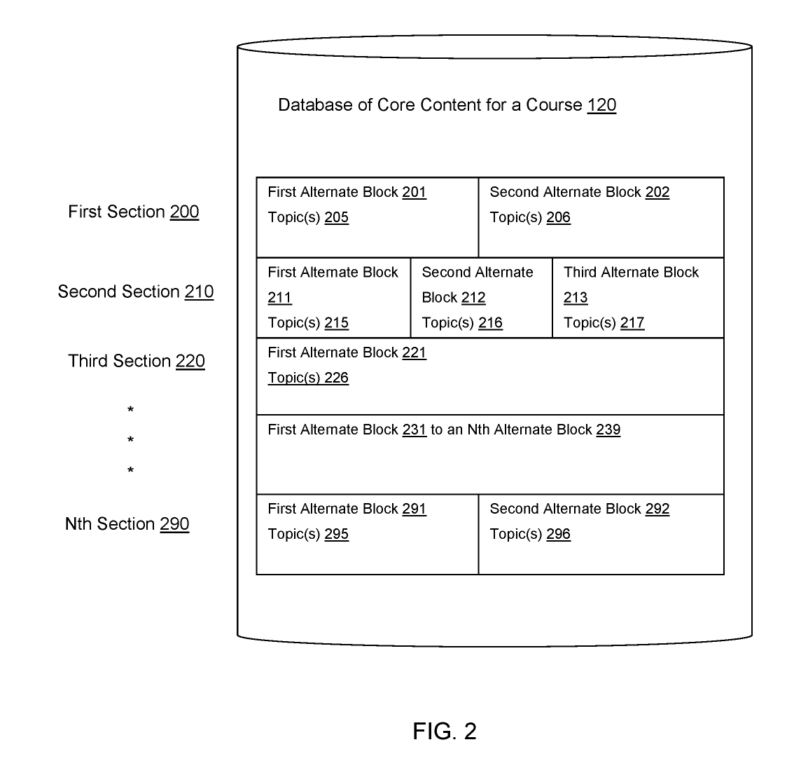

As a non-limiting example, FIG. 2 illustrates a possible database 120 of core content for a course. The illustrated core content has a first section 200, a second section 210, a third section 220 and up to an Nth section 290. The first section 200 comprises a first alternate block 201 and a second alternate block 202. The second section 210 comprises a first alternate block 211, a second alternate block 212 and a third alternate block 213. The third section 220 comprises only a first alternate block 221. The Nth section 290 comprises a first alternate block 291 and a second alternate block 292. It should be appreciated that the core content may be organized as any number of desired sections and that each section may comprise any number of desired alternative blocks.

As a specific example, if the course is an introductory computer science course, a first section 200 may comprise a first alternative block which emphasizes computer hardware and a second alternative block which emphasizes computer software. A second section 210 may comprise a first alternative block which emphasizes a history of computer devices, a second alternative block which emphasizes current applications of computers and a third alternative block which emphasizes future uses of computers.

In some embodiments, the system may include a teacher interrogatory engine 130, operating on the one or more hardware servers 115. The teacher interrogatory engine 130 may have one or more software programs and/or applications running on a computer processing unit to determine one or more questions to ask the teacher. In one embodiment, the teacher interrogatory engine 130 may have a database interface to read from the database 120 the one or more questions to ask the teacher 100 regarding the course. The teacher interrogatory engine 130 may have an Internet or computer network interface operating through one or more routers to transmit a display with the questions to a client device 110 operated by a teacher 100 and to receive one or more answers from the client device 110 operated by the teacher 100. The teacher interrogatory engine 130 may be connected and/or in communication with the table of contents generator 140.

The teacher interrogatory engine 130 may transmit one or more questions that are displayed on a client device 110 operated by a teacher 100. The questions may be of any desired type, such as, as non-limiting examples, yes/no, multiple choice or requesting an answer on a scale, such as between 1 and 100. The questions may also be stored in the database 120 along with the core content of the course. The questions may be in a hierarchy where future questions are determined based on the answers to earlier questions or may be static and the same questions are always asked in the same order for the course. (Step 510) The teacher interrogatory engine 130 may also receive information and/or one or more answers from the client device 110 operated by the teacher 100.

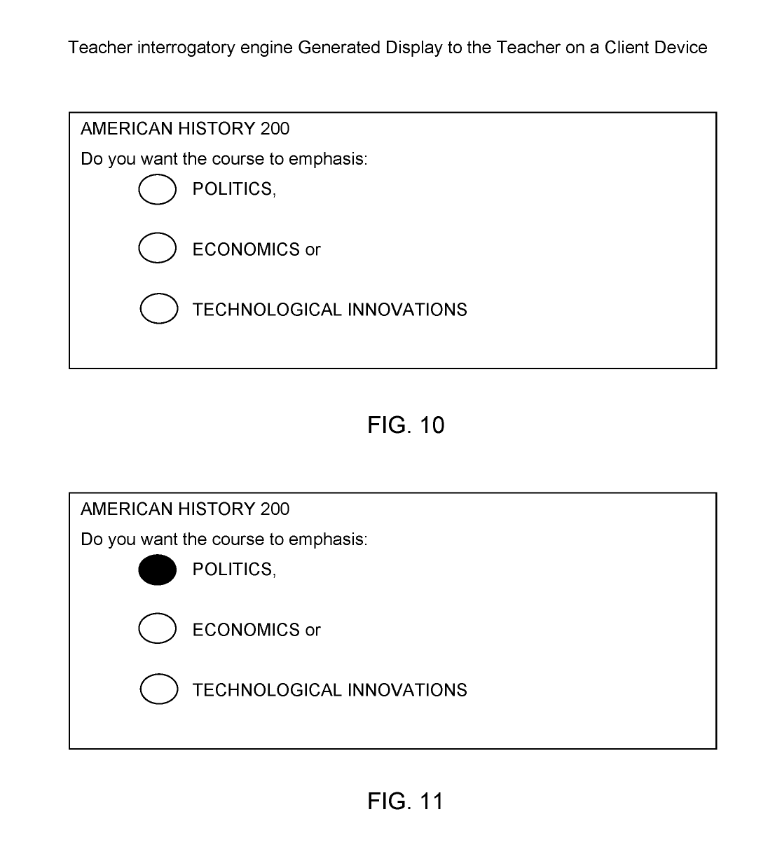

As a non-limiting example, if the course is an American history course, the teacher interrogatory engine 130 may transmit a first question to the teacher 100 of whether the course should emphasis the topics of politics, economics or technological innovations. An example of this question as displayed on the client device of the teacher 100 is illustrated in FIG. 10. The teacher 100 may select one, such as politics, as illustrated in FIG. 11, and transmit this back as a first answer to the teacher interrogatory engine 130.

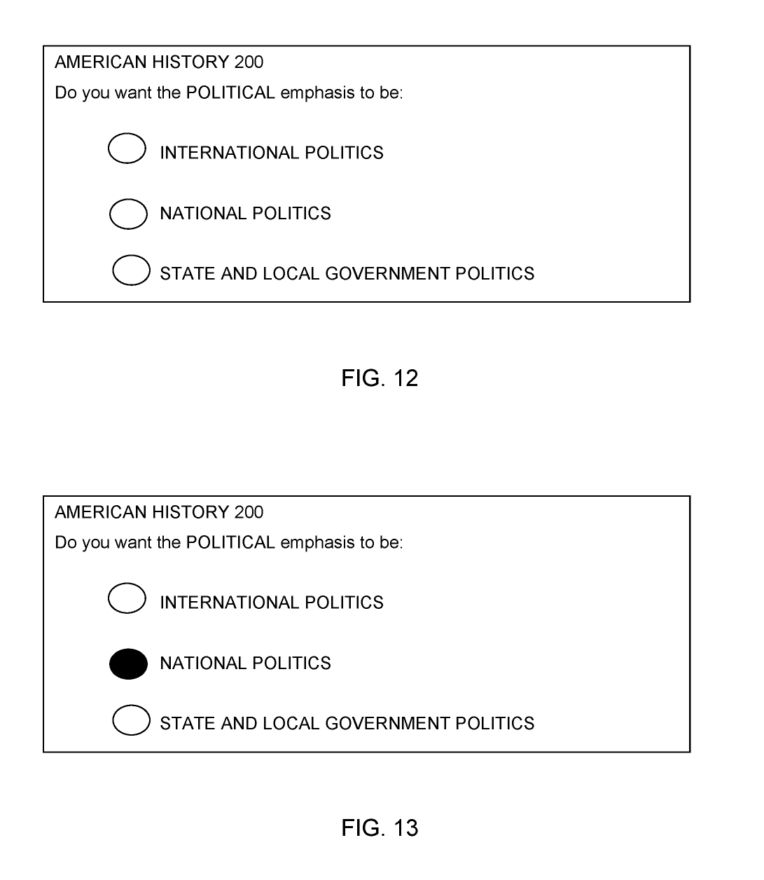

After receiving the first answer, the teacher interrogatory engine 130 may transmit a second question to the teacher 100, which may be selected based on the answer to the first question. As an example, the second question may be should the political emphasis be on international politics, national politics or state and local government politics. This question is illustrated in FIG. 12. The teacher 100 may select national politics, as illustrated in FIG. 13, and transmit national politics back as a second answer to the teacher interrogatory engine 130. Using this method, the teacher interrogatory engine 130 may ask any number of desired questions and receive any number of answers back from the teacher 100.

An input of a table of contents generator 140 may receive the one or more answers from the teacher interrogatory engine 130. The answer(s) may be used to select an alternative block in each of one or more sections and/or the answer(s) may be used to modify one or more of the selected alternative blocks. The selected alternative blocks may be modified by any desired method.

As non-limiting examples, the selected alternative blocks may be modified by being replaced with substitute alternative blocks, content material added, removed or altered, reading assignments changed, increased or shortened, introductory materials added, introductory materials removed, advanced materials added and/or advanced material removed. (Step 520)

In some embodiments, a current events detector 150 may parse, such as read, through a plurality of current event records (which is hereby defined to include current news events and current academic publications) to determine one or more current events relevant to one or more selected alternative blocks. (Step 600) The current events detector 150 may modify one or more selected alternative blocks based on the current event determined by the current events detector 150. (Step 610)

The current events detector 150 may have one or more software programs and/or applications running on a computer processing unit to determine one or more current events relevant to one or more selected alternative blocks. In one embodiment, the current events detector 150 may have an RSS feed reader monitoring one or more RSS feeds. The current events detector may look for keywords in the RSS feed that match topics of selected alternative blocks. In another embodiment, the current events detector may parse through current news stories using text matching to determine current news stories that are related to a topic of one or more alternative blocks. Current events with keywords that match a topic of an alternative block may be used to select or modify the matching alternative block. The current events detector 150 may have an Internet or computer network interface operating through one or more routers to receive one or more current news events (which include new findings in academic publications). The current events detector 150 may be connected and/or in communication with the table of contents generator 140.

As a non-limiting example, if a new particle in particle physics has been discovered in a current event record (such as a current academic publication), a reading assignment on the new particle may be added to a section discussing the known particles in a course on particle physics. It should be appreciated that a selected alternative block may be modified based on one or more answers from the teacher 100 and by one or more current event records, truly allowing for a highly customized table of contents for the course.

An output of the table of contents generator 140 may transmit the customized table of contents to the client device 110 operated by the teacher 100. In preferred embodiments, the customized table of contents will comprise one and only one alternative block from each section in the plurality of sections.

The customized table of contents may comprise one or more modified alternative blocks from different sections. The modified alternative blocks may be modified based on the answer(s) from the teacher 100 and/or modified based on one or more current events determined by the current events detector 150. (Step 620) The teacher 100 may then use the customized table of contents generated using the above described methods to teach the course.

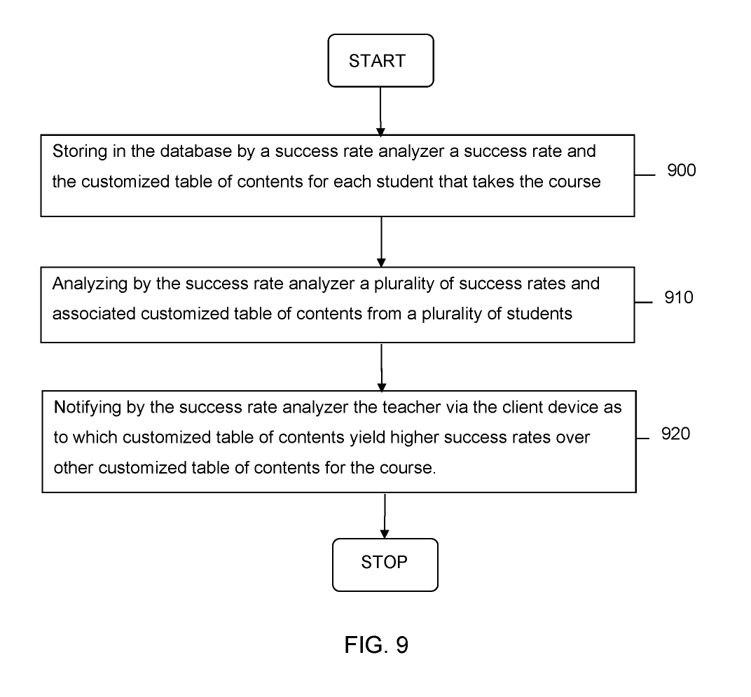

Referring to FIG. 9, a success rate analyzer 145, operating on the one or more hardware servers 115, may store in the database 120 a success rate with an associated customized table of contents for each student 105 that takes the course. (Step 900) The rate of success may be a grade the student 105 received from the teacher 100 while taking the course or any other desired indicator of the student's success in mastering the material in the course.

The success rate analyzer 145 may analyze a plurality of success rates and associated customized table of contents from a plurality of students 105 to determine the customized table of contents that led to higher success rates. (Step 910)

The success rate analyzer 145 may also notify the teacher 100 via the client device 110 as to which customized table of contents yielded higher success rates over other customized table of contents for the course. (Step 920) This may be done by displaying graphics, statics and/or making one or more recommendations on the client device 110 to the teacher 100.

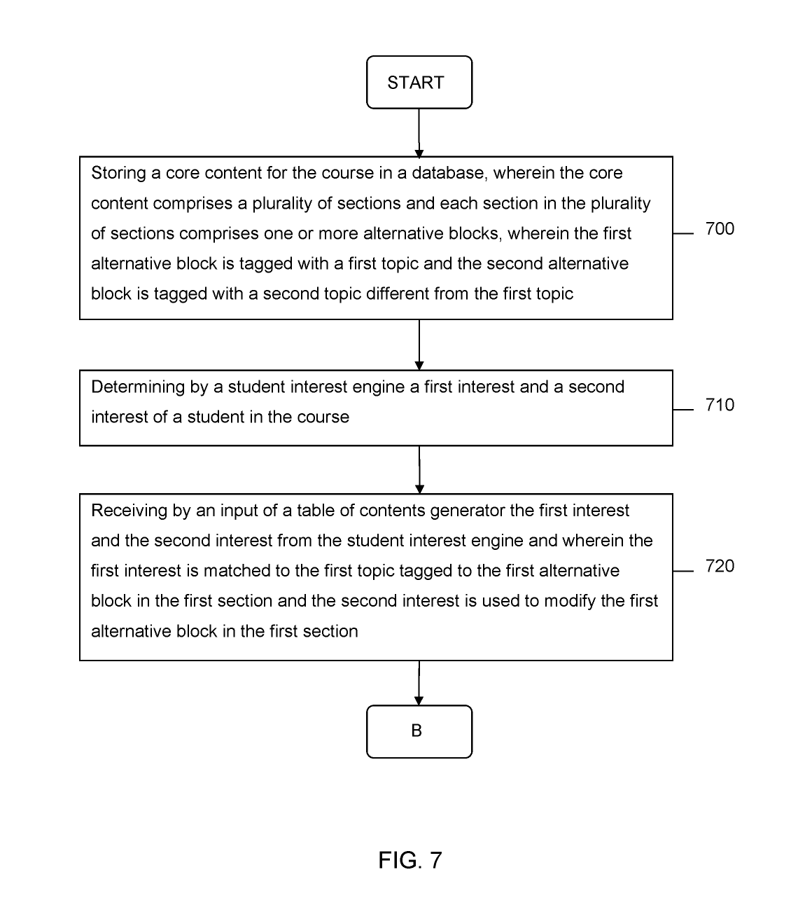

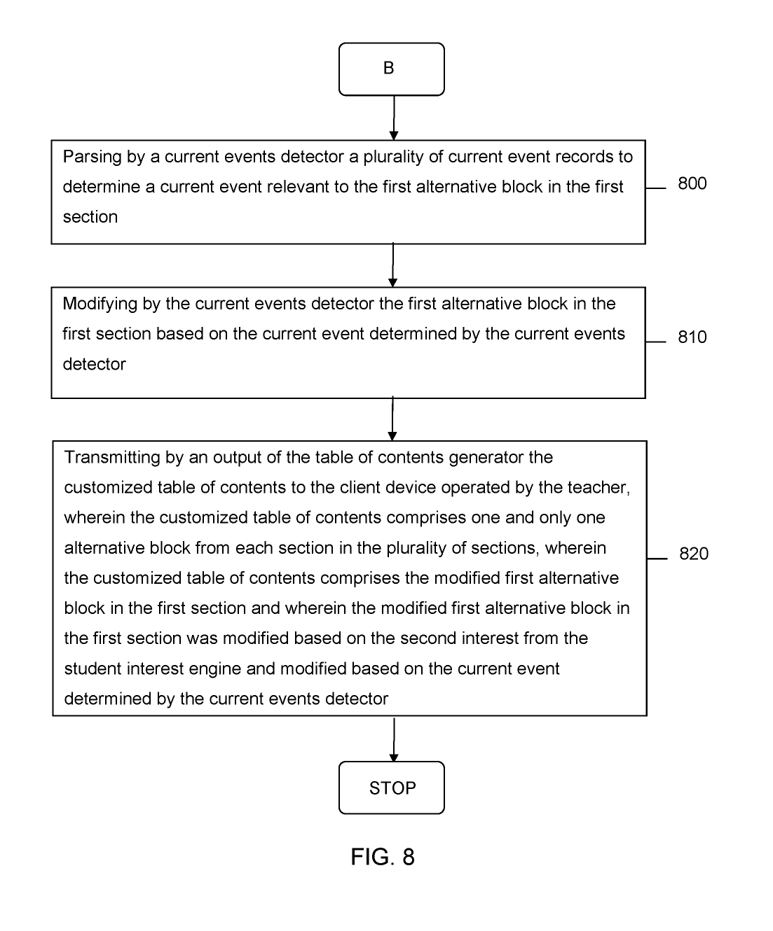

Referring to FIGS. 7 and 8, a customized table of contents may be generated for each student 105 in a class (which could be one or more), i.e., there may be as many customized table of contents as there are students 105 in the course. Alternatively, a single customized table of contents for the course may be based on the most common interests for all of the students 105 enrolled in the course.

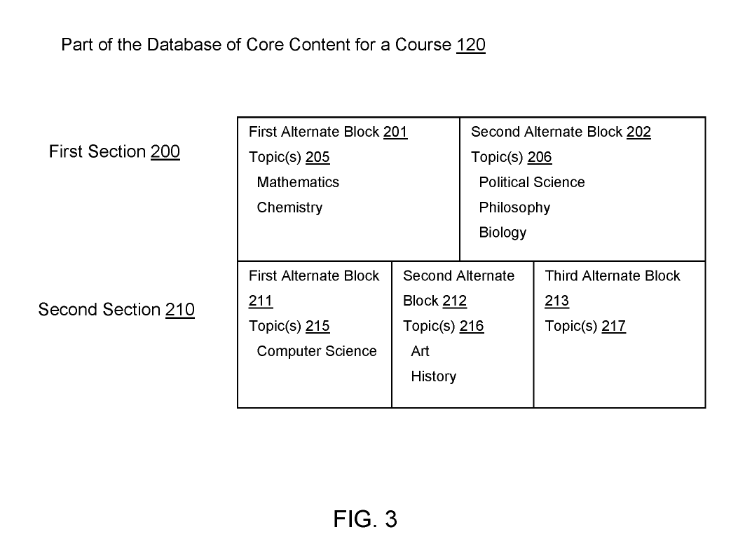

In this embodiment, the core content for the course may be stored in the database 120 as previously described and as illustrated in FIG. 2. Referring to FIG. 3, additional information may be added to the core content stored in the database 120. Specifically, zero, one or a plurality of topics may be tagged to each alternative block in each section. (Step 700)

As non-limiting examples, the first section 200 may comprise a first alternative block 201 with the tagged topics 205 of “mathematics” and “chemistry” and a second alternative block 202 with the tagged topics 206 of “political science,” “philosophy” and “biology.” The second section 210 may comprise a first alternative block 211 with the tagged topics 215 of “computer science,” a second alternative block 212 with the tagged topics 216 of “art” and “history” and a third alternate block 213 with no tagged topics 217 identified.

A student interest engine 135, operating on the one or more hardware servers 115, may determine a plurality of interests for one or more students 105 currently taking the course. If a customized table of contents is desired for a single student 105, the student interest engine 135 may determine one or more interests for that student 105. If a customized table of contents is desired for an entire course, the student interest engine 135 may determine one or more of the most common interests for all of the students 105 enrolled in the course. In preferred embodiments, as many interests are found as possible either for the student 105 or for all of the students 105.

The student interest engine 135 may determine one or more interest for the students 105 using any desired methods. The student interest engine 135 may have one or more software programs and/or applications running on a computer processing unit to determine one or more interests of one or more students relevant to one or more topics of the selected alternative blocks. As an example, the student interest engine 135 may have an API or other computer interface to review student records and/or social media. The student interest engine 135 may look for keywords in the student records and/or social media that match one or more topics of the alternative blocks in the course. Alternative blocks with topics that match a student interest may be selected over alternative blocks without a topic that matches a student interest. The student interest engine 135 may have an Internet or computer network interface operating through one or more routers to receive the student records and/or social media. The student interest engine 135 may be connected and/or in communication with the table of contents generator 140.

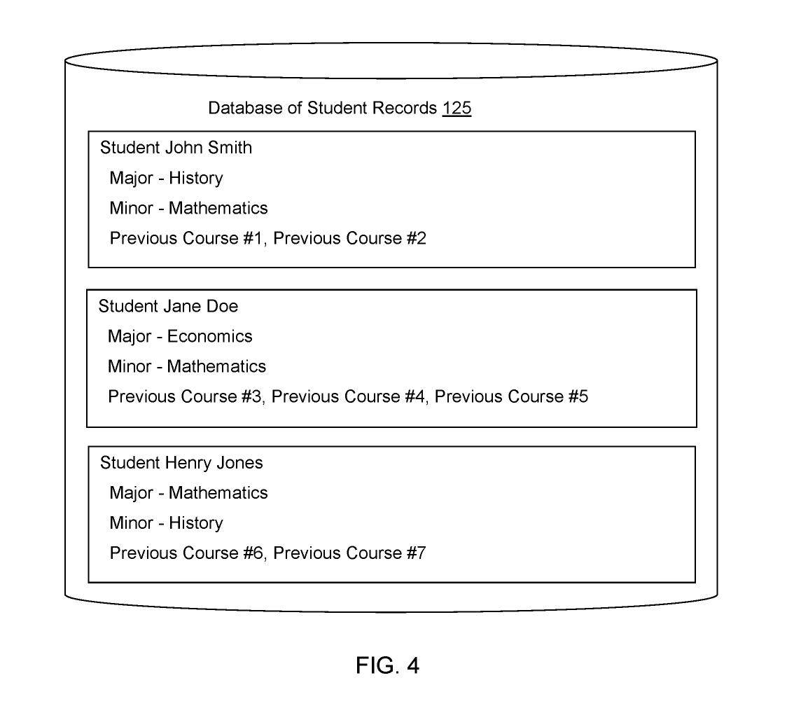

As a non-limiting example, referring to FIG. 4, the student interest engine 135 may parse a database of student records 125 searching for a plurality of majors or minors for the students 105 in the course. The majors and/or minors may be assumed to be an interest for the student 105 having the major or minor. In some embodiments, the numbers of majors and minors for the same area, i.e., history or economics, may be added together. The interests of each student may be added together to get student interest totals for one or more student interests. As an example, it may be found that 6 students have an interest in mechanical engineering. The student interests that are the most common (have the greatest number of students with those interests) may be matched against the topics associated with each of the alternative blocks. The alternative blocks with topics that match the interests most common to the students may be selected over alternative blocks with topics that do not match the interests most common to the students.

As a specific example, the student John Smith has a minor of mathematics, the student of Jane Doe has a minor in mathematics and the student Henry Jones has a major in mathematics. Thus, a course with these students 105 may emphasize mathematics by selecting alternative blocks with mathematics as a topic thereby having more challenging mathematically problems than a course with no or very few students 105 with a mathematics major or minor.

Alternatively, or in addition, the student interest engine 135 may parse the database of student records 125 for previous courses taken by one or more students 105. The student interest engine 135 may use these previously taken courses to infer areas of interests for the students 105 taking the courses.

As a non-limiting example, if many of the students 105 have taken history courses, any historical aspects of the course may be emphasized in the generated customized table of contents. As another example, if many of the students 105 have taken public speaking classes, class presentations may be added to the generated customized table of contents.

Alternatively, or in addition, the student interest engine 135 may transmit one or more questions to one or more students 105 to ask the student 105 about possible interests. The student interest engine 135 may use the answers from the students 105 to determine the interests of the students 105. As a specific example, a course in business might ask students 105 whether they are more interested in accounting or marketing and then select one or more alternative blocks with a topic of the selected interest and/or modify one or more alternative block by removing and/or adding projects based on the selected interest. (Step 710)

As another alternative, or in addition, the system or the teacher 100 may select the most closely matching alternative block based on the tagged topics for each alternative block and any desired matching (or similar) learning objectives. As non-limiting examples, the learning objectives may be the learning objectives of the class, learning objectives for the majors and/or minors of the students in the class, learning objectives in an external framework for the students, learning objectives for 21st century skills and/or learning objectives of the learning institution offering the course. Thus, these learning objectives may be also be used in selecting alternative blocks in one or more of the sections.

An input of a table of contents generator 140 may receive one or more interests of the student 105 or students 105. The one or more interests may be matched to one or more topics tagged to alternative blocks in the sections. Alternative blocks tagged with topics that match the student or students' interests are preferably selected over alternative blocks with no or fewer matches of the student or students' interests. In addition, the student or students' interests may be used to modify the selected alternative blocks to further customize the course to the student 105 or students 105.

As a non-limiting example, if the student 105 or students 105 are found to be interested in psychology, then alternative blocks tagged with psychology may be chosen over alternative blocks that are not tagged with psychology. In addition or alternatively, selected alternative blocks may be modified to add or emphasize a psychological aspect in one or more sections of the course based on the student or students' interests. (Step 720)

As another example, a history course may have history majors as well as education majors hoping to teach social studies and/or other students hoping to pursue health-related professions. If there are interests that are common to many of the students in the course, material related to these interests may be added to the customized table of contents.

As a specific non-limiting example, if a topic in a course is a significant historical matter and several students are interest in health issues, alternative blocks dealing with health issues may be selected over alternative blocks without health issues. Other students may be more interested in the contemporary politics or weapon manufacturing technologies so alternative blocks may also be selected for these interests over other alternative blocks that do not cover these topics. This selection process of preferred alternative blocks may only be performed if alternative blocks having these tagged topics exist in the core content. Thus, it should be appreciated that the core content preferably comprises as many alternative blocks as possible (although this raises the cost and difficulty in creating the core content) with each alternative block comprising material related to different possible areas of interest of students.

In some embodiments, a current events detector 150 may parse through a plurality of current event records to determine one or more current events relevant to one or more selected alternative blocks. (Step 800) The current events detector 150 may modify one or more selected alternative blocks based on the current event determined by the current events detector 150. (Step 810)

As a non-limiting example, if a financial crisis hits the economy of a country and is recorded in a current event record (such as a current academic publication), a writing assignment discussing the financial crisis for the country may be added to a section discussing recent financial crises in a course on macroeconomics. It should be appreciated that a selected alternative block may be modified based on one or more answers from the teacher 100 and by one or more current event records, thereby generating a highly customized table of contents for the course.

The table of contents generator 140 may generate the customized table of contents. Specifically, all of the selected and possibly modified alternative blocks (one and preferably only one from each and every section) are combined to create the customized table of contents. An output of the table of contents generator 140 may transmit the customized table of contents to the client device 110 operated by the teacher 100. The customized table of contents thus generated may comprise one and only one alternative block from each section in the plurality of sections and the customized table of contents may comprise one or more modified alternative blocks. (Step 820)

In some embodiments, an overarching control module 170 may be used to either suggest particular alternative blocks based on previously selected alternative blocks and/or to prevent particular alternative blocks from being selected based on previously selected alternative blocks. As a specific example, the overarching control module 170 may provide a choice between an alternative block on fruits and an alternative block on vegetables, but only after the teacher 100 had previously selected an alternative block on plants in general. In other words, once the teacher 100 selected the alternative block on plants in general, the alternative block on fruits and the alternative block on vegetables would become available for selection by the teacher. In this manner, the overarching control module 170 may provide guidance to the teacher 100 in selecting alternative blocks and not allow all combinations of alternative blocks to be selected in the plurality of sections.

Alternatively, or in addition, the overarching control module 170 may be used to monitor any desired feature or features of the selected alternative blocks in the plurality of sections. The overarching control module 170 may monitor the selected alternative blocks in real time as the teacher selects the alternative blocks or the overarching control module 170 may be used to analyze all of the selected alternative blocks in the final custom table of contents.

As an example, the overarching control module 170 may be used to monitor the balance of the homework assignments in the selected alternative blocks. Thus, if all or most of the selected alternative blocks have reading assignments, but provide no chance to demonstrate or apply the knowledge, the teacher 100 may receive an informational warning, the teacher 100 may receive suggestions to select alternative blocks that would balance the homework and/or the teacher 100 may be prevented from selecting further alternative blocks containing reading assignments.

As another example, the overarching control module 170 may be used to monitor the content of the selected alternative blocks to insure the selected alternative blocks adequately cover the subject matter that is intended to be covered in the course. Thus, if a course is intended to cover Art History of Mediterranean, European, Asian and African arts, but all or most of the selected alternative blocks lean or only cover Mediterranean art, the teacher 100 may be informed of the imbalance. In addition, alternative blocks covering European, Asian and/or African arts may be suggested to the teacher 100 to help balance the course and to make sure the course covers all of its intended topics. In some embodiments, the overarching control module 170 may block or prevent certain combinations of alternative blocks from being selected by the teacher 100 that are known to produce an undesirable customized table of contents.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A system for creating a customized table of contents for a course, comprising:
a database, operating on one or more hardware servers, storing a core content for the course, wherein the core content comprises a plurality of sections and each section in the plurality of sections comprises one or more alternative blocks, wherein a first section and a second section in the plurality of sections comprise a different number of alternative blocks, wherein the first section comprises a first alternative block and a second alternative block, wherein the first alternative block is tagged with a first topic and the second alternative block is tagged with a second topic different from the first topic and wherein the core content comprises content for a plurality of different possible table of contents;
a student interest engine, operating on the one or more hardware servers, configured to determine a first interest and a second interest of a student in the course; and
a table of contents generator, operating on the one or more hardware servers, comprising an input to receive the first interest and the second interest of the student and an output to transmit the customized table of contents to a client device operated by the student or a teacher, wherein the first interest of the student is matched to the first topic tagged to the first alternative block in the first section and the second student interest is used to modify the first alternative block in the first section, wherein the customized table of contents comprises one and only one alternative block from each section in the plurality of sections and wherein the customized table of contents comprises the modified first alternative block in the first section.

2. The system of claim 1, wherein the student interest engine parses a student record for a major of the student in the course and at least partially basis the first student interest or the second student interest on the major of the student.

3. The system of claim 1, wherein the student interest engine parses a student record for a minor of the student in the course and at least partially basis the first student interest or the second student interest on the minor of the student.

4. The system of claim 1, wherein the student interest engine parses a student record for previous courses taken by the student in the course and at least partially basis the first student interest or the second student interest on the previous courses taken by the student.

5. The system of claim 1, wherein the student interest engine displays one or more questions to, and receives one or more answers from, the client device operated by the student and at least partially basis the first student interest or the second student interest on the one or more answers received from the student.

6. The system of claim 1, wherein the first alternative block is tagged with a first plurality of topics and the second alternative block is tagged with a second plurality of topics and wherein the first plurality of topics do not overlap the second plurality of topics.

7. The system of claim 1, wherein the first section comprises a course project and the second section comprises a course reading assignment.

8. A method for creating a customized table of contents for a course, comprising the steps of:
storing a core content for the course in a database operating on one or more servers, wherein the core content comprises a plurality of sections and each section in the plurality of sections comprises one or more alternative blocks, wherein a first section and a second section in the plurality of sections comprise a different number of alternative blocks, wherein the first section comprises a first alternative block and a second alternative block, wherein the first alternative block is tagged with a first topic and the second alternative block is tagged with a second topic different from the first topic and wherein the core content comprises content for a plurality of different possible table of contents;
determining by a student interest engine, operating on the one or more hardware servers, a plurality of interests for a plurality of students currently taking the course and determining a first interest and a second interest that are the most common for the plurality of students;
receiving by an input of a table of contents generator, operating on the one or more servers, the first interest and the second interest from the student interest engine, and wherein the first interest is matched to the first topic tagged to the first alternative block in the first section and the second interest is used to modify the first alternative block in the first section; and
transmitting by an output of the table of contents generator the customized table of contents to the client device operated by the teacher, wherein the customized table of contents comprises one and only one alternative block from each section in the plurality of sections and wherein the customized table of contents comprises the modified first alternative block in the first section.

9. The method of claim 8, further comprising the steps of:
parsing by the student interest engine a plurality of student records for a plurality of majors for the plurality of students in the course; and
at least partially basing the first student interest or the second student interest on the plurality of majors of the plurality of students.

10. The method of claim 8, further comprising the steps of:
parsing by the student interest engine a plurality of student records for a plurality of minors for the plurality of students in the course; and
at least partially basing the first student interest or the second student interest on the plurality of minors of the plurality of students.

11. The method of claim 8, further comprising the steps of:
parsing by the student interest engine a plurality of student records for previous courses taken by the plurality of students in the course; and
at least partially basing the first student interest or the second student interest on the previous courses taken by the plurality of students.

12. The method of claim 8, further comprising the steps of:
displaying by the student interest engine one or more questions to, and receives one or more answers from, each of a plurality of client devices operated by the plurality of students; and
at least partially basing the first student interest or the second student interest on the one or more answers received from each of the plurality of students.

13. The method of claim 8, further comprising the steps of:
tagging the first alternative block with a first plurality of topics; and
tagging the second alternative block with a second plurality of topics, wherein the first plurality of topics do not overlap the second plurality of topics.

14. The method of claim 8, wherein the first section comprises a course project and the second section comprises a course reading assignment.

15. A method for creating a customized table of contents for a course, comprising the steps of:
storing a core content for the course in a database operating on one or more servers, wherein the core content comprises a plurality of sections and each section in the plurality of sections comprises one or more alternative blocks, wherein a first section and a second section in the plurality of sections comprise a different number of alternative blocks, wherein the first section comprises a first alternative block and a second alternative block, wherein the first alternative block is tagged with a first topic and the second alternative block is tagged with a second topic different from the first topic and wherein the core content comprises content for a plurality of different possible table of contents;
determining by a student interest engine, operating on the one or more hardware servers, a first interest and a second interest of a student in the course;
receiving by an input of a table of contents generator, operating on the one or more servers, the first interest and the second interest from the student interest engine, and wherein the first interest is matched to the first topic tagged to the first alternative block in the first section and the second interest is used to modify the first alternative block in the first section;
parsing by a current events detector, operating on the one or more servers, a plurality of current event records to determine a current event relevant to the first alternative block in the first section;
modifying by the current events detector the first alternative block in the first section based on the current event determined by the current events detector; and
transmitting by an output of the table of contents generator the customized table of contents to the client device operated by the teacher, wherein the customized table of contents comprises one and only one alternative block from each section in the plurality of sections, wherein the customized table of contents comprises the modified first alternative block in the first section and wherein the modified first alternative block in the first section was modified based on the second interest from the student interest engine and modified based on the current event determined by the current events detector.

16. The method of claim 15, further comprising the steps of:
parsing by the student interest engine a student record for a major of the student in the course; and
at least partially basing the first student interest or the second student interest on the major of the student.

17. The method of claim 15, further comprising the steps of:
parsing by the student interest engine a student record for a minor of the student in the course; and
at least partially basing the first student interest or the second student interest on the minor of the student.

18. The method of claim 15, further comprising the steps of:
parsing by the student interest engine a student record for previous courses taken by the student in the course; and
at least partially basing the first student interest or the second student interest on the previous courses taken by the student.

19. The method of claim 15, further comprising the steps of:
displaying by the student interest engine one or more questions to, and receives one or more answers from, the client device operated by the student; and
at least partially basing the first student interest or the second student interest on the one or more answers received from the student.

20. The method of claim 15, further comprising the steps of:
tagging the first alternative block with a first plurality of topics; and
tagging the second alternative block with a second plurality of topics, wherein the first plurality of topics do not overlap the second plurality of topics.
